(19) United States
(12) Patent Application Publication
(10) Pub. No.: US 2008/0201298 A1
(43) Pub. Date: Aug. 21, 2008

(54) ADMINISTRABLE COMMAND LINE INTERFACE

(75) Inventor: Emmanuel Grinspan, Raanana (IL)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/111,699

(22) Filed: Apr. 29, 2008

Related U.S. Application Data
(63) Continuation of application No. 11/237,510, filed on Sep. 28, 2005, now abandoned.

(51) Int. Cl. G06F 17/30; G06F 3/00

(52) U.S. Cl. 707/2; 715/762; 707/E17.001

(57) ABSTRACT

A command line interface administration for a data processing system is provided. According to one embodiment, a method for an improved command line interface for a data processing system in a telephony device is provided. The method comprising administering a language definition for an improved command line interface, the improved command line interface having a command and a keyword and storing the language definition.

### FIELD OF THE INVENTION

The present invention relates to command line interface in a data processing unit, and more particularly, to a command line interface having an administrable language definition and/or an administrable help definition.

### BACKGROUND

A command line interface (CLI) is a method of interfacing with a data processing unit via text command. A data processing unit usually displays a prompt wherein a command is entered via an input device such as a keyboard. Once the command is terminated, typically using the enter key, the command is executed by the computer. This is in contrast to graphical user interface (GUI) commands that are typically entered in particular locations on a monitor, whereby a mouse is used to change monitor locations. A benefit of the CLI is that the text command may be saved in a script, wherein the script may interface with the CLI versus a human user. Using a script is especially useful when the same set of commands are frequently used. Thus, the human user does not have to re-enter the command information.

Many systems provide the CLI, for example, to allow users to administer system information, check status, and for maintenance information. The commands and the keywords used in the CLI are typically left to the discretion of each vendor providing the CLI. Commonly, devices from different vendors have a different CLI. Furthermore, different versions of devices from the same vendor may have different CLI.

There exists a need for an improved CLI.

### SUMMARY OF THE INVENTION

In one aspect of the present invention, a method for an improved command line interface for a data processing system in a telephony device is provided. The method comprising administering a language definition for an improved command line interface, the improved command line interface having a command and a keyword, and storing the language definition.

In another aspect of the present invention, a software for providing a language definition is provided. The software embodied in at least one computer-readable medium and when executed by one or more processors operable to accept user input from an input device and to administer a language definition for an improved command line interface via the user input, the improved command line interface having a command and a keyword.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary schematic of a prior art telephony system having a command line interface;

FIG. 2 illustrates an exemplary schematic of a telephony system having an improved command line interface in accordance to the present invention;

FIG. 3a illustrates an exemplary user input for changing a command in accordance to the present invention;

FIG. 3b illustrates an exemplary user input for changing a keyword in accordance to the present invention;

FIG. 4a illustrates an exemplary user input for removing a command in accordance to the present invention;

FIG. 4b illustrates an exemplary user input for removing a keyword in accordance to the present invention;

FIG. 5a illustrates an exemplary user input for hiding a command in accordance to the present invention;

FIG. 5b illustrates an exemplary user input for hiding a keyword in accordance to the present invention;

FIG. 6a illustrates an exemplary user input for unhiding a command in accordance to the present invention;

FIG. 6b illustrates an exemplary user input for unhiding a keyword in accordance to the present invention;

FIG. 7a illustrates an exemplary user input for moving a command to a different mode in accordance to the present invention;

FIG. 7b illustrates an exemplary user input for moving a keyword to a different mode in accordance to the present invention;

FIG. 8a illustrates an exemplary user input for copying a command to a mode in accordance to the present invention;

FIG. 8b illustrates an exemplary user input for copying a keyword to a mode in accordance to the present invention;

FIG. 9 illustrates an exemplary user input for saving a language definition in accordance to the present invention; and

FIG. 10 illustrates an exemplary user input for loading a language definition in accordance to the present invention.

### DETAILED DESCRIPTION OF THE INVENTION

The invention described herein may employ one or more of the following concepts. For example, one concept relates to an administrable Command Line Interface (CLI). Another concept relates to a language definition for the CLI. Another concept relates to the language definition being defined by a user. Another concept relates to a help definition for the CLI. Another concept relates to the help definition being defined by a user. Another concept relates saving the language definition. Another concept relates saving the help definition. Another concept relates to saving multiple versions of the language definition. Another concept relates to saving multiple versions of the help definition. Still another concept relates to loading the language definition. Yet another concept relates to loading the help definition

The present invention is disclosed in context of use in a telephony system. The principles of the present invention, however, are not limited to use in a telephony system but may be used in system comprising a component having CLI. However, the present invention has particular application to telephony systems, since components within a telephony system often provide the CLI. Additionally, telephony systems often comprise of components that are developed by different vendors or of components having different versions but developed by the same vendor. The present invention is disclosed in terms of a monitor as a display unit. However, any suitable display unit may be used. For example, a display unit may be a television or a teletype. Also, the present invention is disclosed in terms of a keyboard as an input device. A suitable device other than a keyboard may be used to obtain user input. For example, a teletype or a voice recognition interface.

Applicant has recognized that a user of a system might get confused on what to enter when the system includes devices having different CLIs. Consequently, a user may enter commands or keywords meant for one device on another device and thus causing a system failure. Furthermore, having multiple sets of commands and/or keywords is problematic when developing system procedures especially when the procedures are based on the particular CLI. In some cases a user may simply not like the supplied commands and/or keywords and prefers to use something else. Also, a vendor may have multiple customers wanting different CLIs.

Some operating systems, such as UNIX®, provide a way to specify an alternate command via an “alias”. Unix is a registered trademark of The Open Group in the United States and other countries. Aliasing however, has limitations such as it does not allow for alternate keywords. Additionally, not all operating systems provide a way to alias. Therefore, an improved CLI would provide a language definition that is administrable by a user.

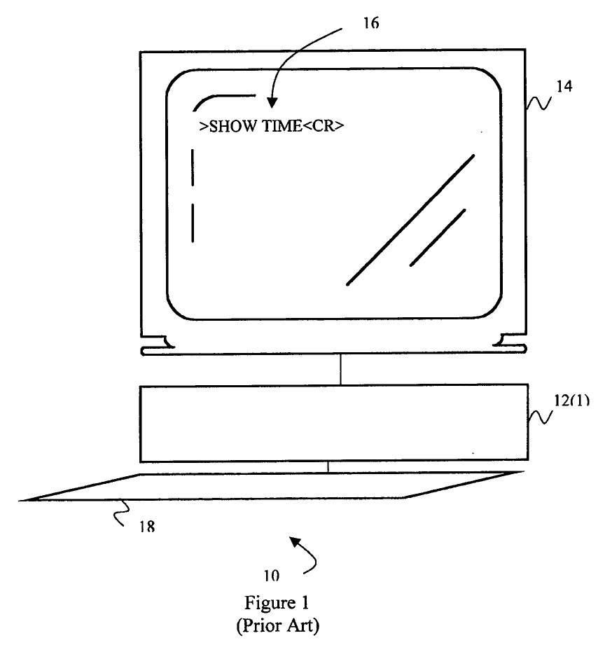

Referring to FIG. 1, a schematic of a prior art telephony system 10 having a CLI is provided. The telephony system 10 includes a keyboard 18, a data processing unit 12(1), e.g. computer, and a monitor 14. The data processing unit 12 is coupled to the keyboard 18 and the monitor 14. Throughout this document, the term “coupled” refers to any direct or indirect communication between two or more elements in memory management system 20, whether or not those elements are in physical contact with one another.

The keyboard 18 allows a user to enter an input 16, which is interpreted by the CLI. The input 16 is displayed to the user on the monitor 14. Additionally, the data processing unit may interpret the input 16 and does processing according to the input. The processing may result in data being displayed to the monitor 14.

In the exemplary illustration in FIG. 1, an input 16 of “SHOW TIME” is provided. Typically, the CLI includes a “>” as a prompt character. However, a character other than “>” may be used, for example “:”. Furthermore, a string of characters may be used to identify the prompt. The CLI uses a terminator to indicate the end of input. The terminator may also be used by the CLI to indicate to start interpreting the input. “<CR>” is used as the terminator indicator throughout.

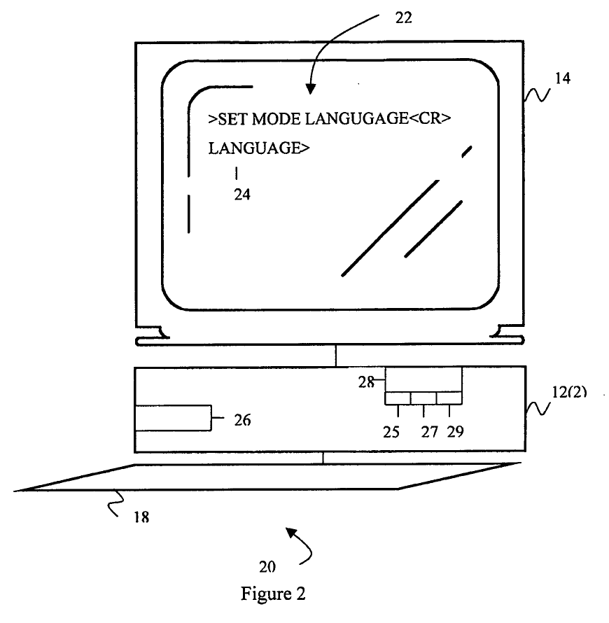

Now referring to FIG. 2, exemplary schematic of a telephony system 20 having an improved CLI in accordance to the present invention is provided. The telephony system 20 includes a keyboard 18, a data processing unit 12(2), and a monitor 14. The data processing unit 12(2) is coupled to the keyboard 18 and the monitor 14. The data processing unit 12(2) may be further coupled to a device in the telephony system 20.

The data processing unit 12(2) includes a hardware device 26, memory unit 28, and the improved CLI 25. The data processing unit 12(2) may further include a user defined language definition 29 and a help definition 27. The defined language definition 29 and/or the help definition 27 may alternatively be stored in a device coupled to the data processing unit 12(2).

The improved CLI 25 may include software, hardware, or combinations thereof. The improved CLI 25 allows a user to administer a language definition 29, interpret user input, and may provide results. The improved CLI 25 may communicate with other devices coupled to the data processing unit 12(2) to facilitate providing the results. The improved CLI 25 includes keywords and commands. A keyword is a string defined by the improved CLI 25 that may be used to convey meaning to the improved CLI 25. For example, a keyword may be TIME or SHOW. A command is one or more keywords that may convey meaning to the improved CLI 25. For example SHOW TIME may be used to have a system time displayed.

A user enters input for the improved CLI 25. The user may be a human or machine, may be co-located with the data processing unit 12(2) or remotely located, or may provide the input directly or indirectly.

The keywords and commands that are to be used by the improved CLI 25 may be defined in the language definition 29. The language definition may be user administrable. One skilled in the art would appreciation that the language definition 29 may be administered in many ways including creating, modifying, and deleting all or part of the language definition 29.

The keywords and commands that may be displayed as help information may be defined in the help definition 27. The help definition 27 may be user administrable. One skilled in the art would appreciation that the help definition 27 may be administered in many ways including creating, modifying, and deleting all or part of the help definition 27.

The memory unit 28 may be volatile memory, non-volatile memory, or combinations thereof. For example, the memory unit 28 may include Random Access Memory (RAM), Read-only Memory (ROM), or a disk drive.

In one embodiment, the memory unit 28 includes the improved CLI 25, and the hardware device 26 includes a processor, e.g. microprocessor, for executing the improved CLI 25. The language definition 29 and help definition 27 may be stored in the memory unit 28

In another embodiment, the hardware device 26 includes circuitry for the improved CLI 25. For example the hardware device 26 may be an Application Specific Integrated Circuit (ASIC), a Field Programmable Gate Array (FPGA), and the like. The language definition 29 and the help definition 27 may be stored in the memory unit 28

Those skilled in the art would recognize that there may be other embodiments using hardware and/or software of the improved CLI 25, hardware device 26, and memory unit 28. For example, another embodiment may include multiple hardware devices 26 for processing the improved CLI 25. For another example, the language definition 29 may include the help definition 27.

Still referring to FIG. 2, an exemplary embodiment of initiating a language definition mode is provided. The language definition mode facilitates user administration of the language definition 29. Although the exemplary embodiment uses “SET MODE LANGUAGE” 22 to initiate the language definition mode, those skilled in the art would appreciate that a suitable command other than “SET MODE LANGUAGE” 22 may be used. For example, “LANGUAGE”.

In a preferred embodiment, the improved CLI 25 remains in the language definition mode until the user explicitly exits the mode, e.g. the user enters “EXIT”. Additionally, in the preferred embodiment, a prompt 24 indicating that the improved CLI 25 is in the language definition mode is provided. The example of FIG. 2, illustrates “LANGUAGE” 24 to indicate that the improved CLI 25 is in the language definition mode. Those skilled in the art would recognize that other prompts may be used to indicate that the improved CLI 25 is in the language definition mode. In addition, those skilled in the art would recognize that a prompt to indicate the language definition mode is not required. Furthermore, those skilled in the art would recognize that the language definition mode is not required to remain until the user explicitly exits the mode. For example, each command line may indicate a language definition mode via a keyword or command and the command line mode exit after a terminator is entered.

The examples hereinafter are illustrated with a preferred embodiment having the improved CLI 25 remaining in a language definition mode until the user explicitly exits and having a prompt 26 indicating that the improved CLI 25 is in the language definition mode.

In the examples provided hereinafter, the case of the keywords, upper and lower, are used to differentiate keywords and are not meant that the input must be entered in the case shown. Moreover, commands and keywords enclosed in “<>” are to indicate input that may substituted by the user and not that the input includes the “<” or the “>”.

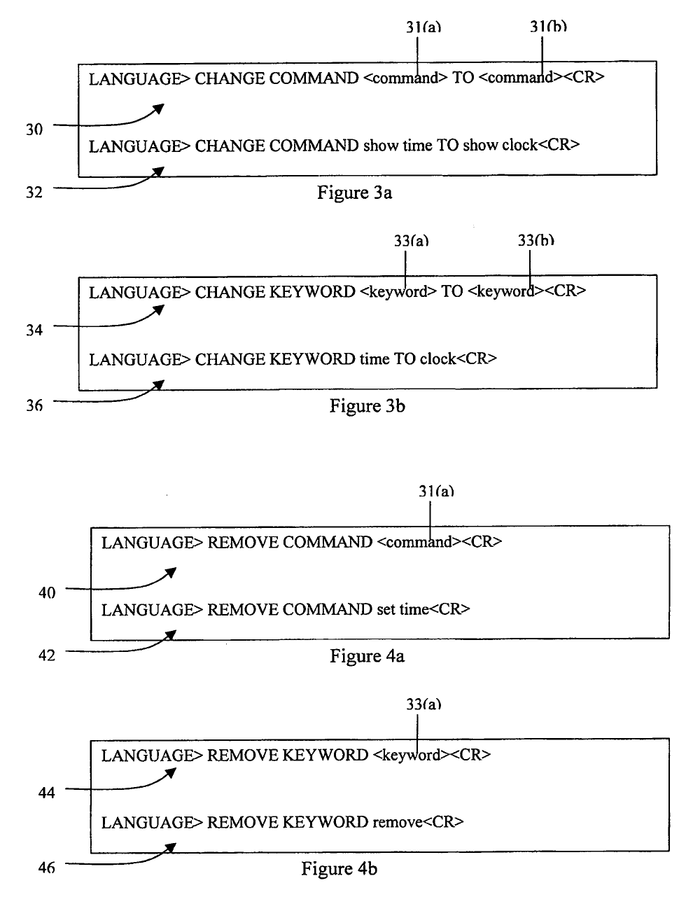

Referring now to FIGS. 2, 3a, and 3b, exemplary user inputs to administer the language definition 29 are provided. The improved CLI 25 provides a change command 30 to facilitate changing a command 31(a) as illustrated in FIG. 3a, and provides a change keyword 34 to facilitate changing a keyword 33(a) as illustrated in FIG. 3b. Therefore, a user may advantageously define the command 31(a) and/or keyword 33(a) preferred by the user.

Referring now to FIGS. 2 and 3a, an exemplary embodiment for changing a command 31(a) to a different command 31(b) is provided via “CHANGE COMMAND <command> TO <command>” 30. For example, the improved CLI 25 allows an input of the command 31(a) “show time” to display the system time. The command 31(a) “show time” may be changed to a different command 31(b), e.g. “show clock”, which is illustrated by “CHANGE COMMAND show time TO show clock” 32. Thus, the language definition 29 is administered so the improved CLI 25 accepts the different command 31(b), “show clock”, instead of the command 31(a), “show time”. Although the exemplary embodiment uses “CHANGE COMMAND <command> TO <command>” 30 to change the command 31(a) to a different command 31(b), those skilled in the art would recognize that other user inputs may by used, such as “MODIFY <command> TO <command>”.

Referring now to FIGS. 2 and 3b, an exemplary embodiment changing a keyword 33(a) to a different keyword 33(b) is provided via “CHANGE KEYWORD <keyword> TO <keyword>” 34. For example, the improved CLI 25 has the keyword 33(a) “time”. The keyword 33(a) “time” may be changed to the different keyword 33(b), e.g. “clock”, which is illustrated by “CHANGE KEYWORD time TO clock” 36. Thus, the language definition 29 is administered so that the improved CLI 25 accepts the different keyword 33(b), “clock”, instead of the keyword 33(a), “time”. Although the exemplary embodiment uses the user input “CHANGE KEYWORD <keyword> TO <keyword>” 34 to change the keyword 33(a) to the different keyword 33(b), those skilled in the art would recognize that other user inputs may by used, such as “UPDATE <keyword> TO <keyword>”.

Referring now to FIGS. 2, 4a, and 4b, more exemplary user inputs to administer the language definition 29 are provided. The improved CLI 25 provides a remove command 40 to facilitate removing a command 31(a) as illustrated in FIG. 4a, and provides a remove keyword 34 to facilitate removing a keyword 33(a) as illustrated in FIG. 4b. Therefore, a user may advantageously remove the command 31(a) and/or keyword 33(a) from use by the improved CLI 25.

Referring now to FIGS. 2 and 4a, an exemplary embodiment for removing a command 31(a) is provided via “REMOVE COMMAND <command>” 40. For example, the improved CLI 25 allows an input of the command 31(a) “set time” to change the system time. It may be desirable to remove the command 31(a) so that it is not used, which is illustrated by “REMOVE COMMAND set time” 42. Thus, the language definition 29 is administered so that the improved CLI 25 does not accept the command 31(a), “set time”. Although the exemplary embodiment uses the user input “REMOVE COMMAND <command>” 40 to remove the command 31(a), those skilled in the art would recognize that other user input may by used, such as “DELETE <command>”.

Referring now to FIGS. 2 and 4b, an exemplary embodiment for removing a keyword 33(a) is provided via “REMOVE KEYWORD <keyword> TO <keyword>” 44. For example, it may be desirable to remove the keyword 33(a) “remove”, which is illustrated by “REMOVE KEYWORD remove” 46. Thus the language definition 29 is administered so that the improved CLI 25, no longer accepts the keyword 33(a), “remove”. Although the exemplary embodiment uses the user input “REMOVE KEYWORD <keyword>” 44 to remove the keyword 33(a), those skilled in the art would recognize that other user input may by used, such as “CANCEL <keyword>.”

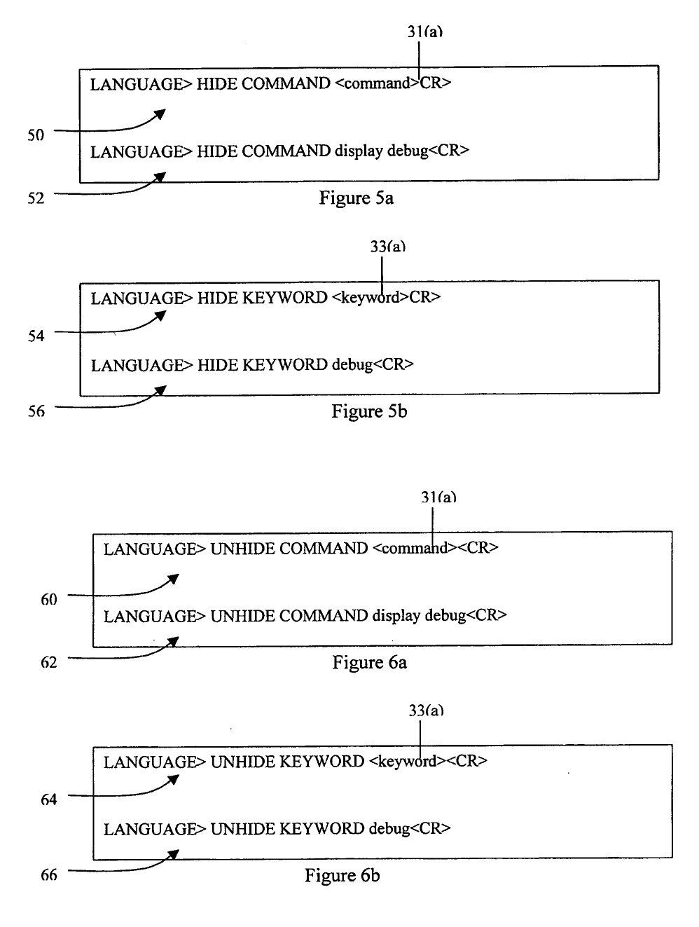

Referring now to FIGS. 2, 5a and 5b, exemplary user inputs to administer the help definition 27 are provided. The improved CLI 25 provides a hide command 50 to facilitate hiding a command 31(a) as illustrated in FIG. 5a, and provides a hide keyword 54 to facilitate hiding a keyword 33(a) as illustrated in FIG. 5b. Therefore, a user may advantageously define the command 31(a) and/or keyword 33(a) to be invisible in the help information without removing the command 31(a) and/or keyword 33(a) from the help definition 27 or language definition 29.

Referring now to FIGS. 2 and 5a, an exemplary embodiment for hiding a command 31(a) is provided via “HIDE COMMAND <command>” 50. For example, the improved CLI 25 allows an input of the command 31(a) “display debug” to display debug information about the system. It may be desirable to hide help information about the command 31(a), which is illustrated by “HIDE COMMAND display debug” 52. Thus, the help definition 27 is administered so that the command 31(a), “display debug”, is no longer available in the help information. Although the exemplary embodiment uses the user input “HIDE COMMAND <command>” 50 to hide the command 31(a), those skilled in the art would recognize that other user input may by used, such as “HIDE <command>”.

Referring now to FIGS. 2 and 5b, an exemplary embodiment hiding a keyword 33(a) is provided via “HIDE KEYWORD <keyword>” 54. For example, it may be desirable to hide the help information about the keyword 33(a) “debug”, which is illustrated by “HIDE KEYWORD debug” 56. Thus, the help definition 27 is administered so that the keyword 33(a), “debug”, is no longer available in the help information. Although the exemplary embodiment uses the user input “HIDE KEYWORD <keyword>” 54 to hide the keyword 33(a), those skilled in the art would recognize that other user input may by used, such as “HIDE <keyword>.”

Referring now to FIGS. 2, 6a and 6b, more exemplary user inputs to change the help definition 27 are provided. The improved CLI 25 provides an unhide command 60 to facilitate displaying a command 31(a) in the help information as illustrated in FIG. 6a, and provides a unhide keyword 64 to facilitate displaying a keyword 33(a) in the help information as illustrated in FIG. 6b. Therefore, a user may advantageously define the command 31(a) and/or keyword 33(a) to be visible in the help information.

Referring now to FIGS. 2 and 6a, an exemplary embodiment for facilitating the help information to be visible for a command 31(a) is provided via “UNHIDE COMMAND <command>” 60. For example, the improved CLI 25 allows an input of the command 31(a) “display debug” to display debug information about the system time; however, for this example the help definition 27 has the “display debug” hidden in the help information. It may be desirable to make help information visible for the command 31(a), which is illustrated by “UNHIDE COMMAND display debug” 62. Thus, the help definition 27 is administered so that the command 31(a), “display debug”, is available in the help information. Although the exemplary embodiment uses the user input “UNHIDE COMMAND <command>” 60 to make the command 31(a) visible, those skilled in the art would recognize that other user input may by used, such as “VISABLE <command>”.

Referring now FIG. 2, and 6b, an exemplary embodiment for facilitating the help information to be visible for a keyword 33(a) is provided via “UNHIDE KEYWORD <keyword>” 64. For example, it may be desirable to make the help information visible for the keyword 33(a) “debug”, which is illustrated by “UNHIDE KEYWORD debug” 66. Thus, the help definition 27 is administered so that the keyword 33(a), “debug”, is available in the help information. Although the exemplary embodiment uses the user input “UNHIDE KEYWORD <keyword>” 64 to make the keyword 33(a) visible, those skilled in the art would recognize that other user input may by used, such as “SHOW <keyword>.”

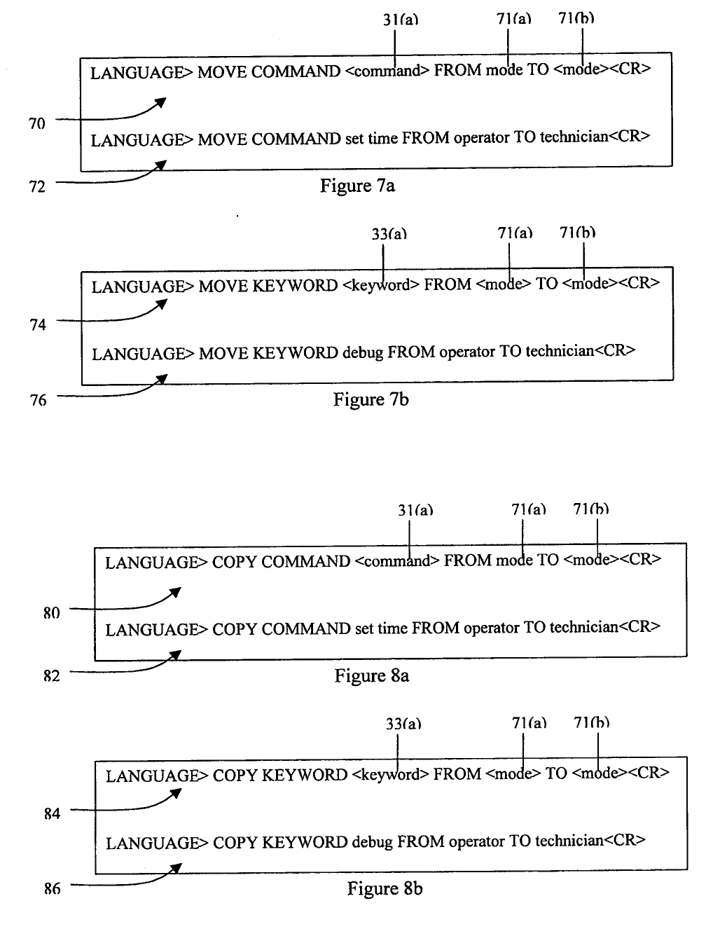

Referring now to FIGS. 2, 7a and 7b, more exemplary user inputs to administer an access mode 71(a) are provided. The improved CLI 25 provides a move command 70 to facilitate changing the access mode 71(a) of a command 31(a) to a different access mode 71(b) as illustrated in FIG. 7a, and provides a move keyword 74 to facilitate changing the access mode 71(a) of a keyword 33(a) to the different access mode 71(b) as illustrated in FIG. 7b. Commonly command and/or keywords are associated with an access mode wherein the access mode 71 defines capabilities of a user. For example, an improved CLI 25 may have the access modes 71 of admin and operator, wherein admin has access to all the commands and keywords and operator has access to a limited set of commands and keywords. The access mode 71 may be implemented in many ways, such as each access mode 71 having a password so that a user may login to an access mode 71. A user may advantageously administer the language definition 29 to change the access mode 71(a) for the command 31(a) and/or keyword 33(a).

Referring now to FIGS. 2 and 7a, an exemplary embodiment for changing a command 31(a) to have a different access mode 71(b) is provided via “MOVE COMMAND <command> FROM <mode> TO <mode>” 70. For example, the improved CLI 25 may allow an input of the command 31(a) “set time” by a user that is in an “operator” mode but not by a user that is in a “technician” mode. It may be desirable to change the access mode 71 for the command 31(a) so that the user in the technician mode may use the command 31(a) but not the user in the operator mode, which is illustrated by “MOVE COMMAND set time FROM operator TO technician” 72. Thus, the language definition 29 is administered so that the command 31(a), “set time” is no longer available for the user in the access mode 71(a), operator mode, but is available for the user in the different access mode 71(b), technician mode. Although the exemplary embodiment uses the user input “MOVE COMMAND <command> FROM <mode> TO <mode>” 70 to change the access mode 71(a), those skilled in the art would recognize that other user input may by used, such as “CHANGE ACCESS <command> FROM <mode> TO <mode>”.

Referring now to FIGS. 2 and 7b, an exemplary embodiment for changing a keyword 33(a) to have a different access mode 71(b) is provided via “MOVE KEYWORD <command> FROM <mode> TO <mode>” 74. For example, the improved CLI 25 may allow an input of the keyword 33(a) “debug” by a user that is in the operator mode but not by a user that is in the technician mode. It may be desirable to change the access mode 71 for the keyword 33(a) so that the user in the technician mode may use the keyword 33(a) but not the user in the operator mode, which is illustrated by “MOVE KEYWORD debug FROM operator TO technician” 76. Thus, the language definition 29 is administered so that the keyword 33(a), “debug” is no longer available for the user in the access mode 71(a), operator mode, but is available for the user in the different access mode 71(b), technician mode. Although the exemplary embodiment uses the user input “MOVE KEYWORD <keyword> FROM <mode> TO <mode>” 74 to change the access mode 71(a), those skilled in the art would recognize that other user input may by used, such as “CHANGE ACCESS <keyword> FROM <mode> TO <mode>”.

Referring now to FIGS. 2, 8a and 8b, more exemplary user inputs to administer an access mode 71(a) are provided. The improved CLI 25 provides a copy command 80 to facilitate providing a different access mode 71(b) for a command 31(a) as illustrated in FIG. 8a, and provides a copy keyword 84 to facilitate providing a different access mode 71(b) for a keyword 33(a) as illustrated in FIG. 8b. Therefore, a user may advantageously administer the language definition 29 to copy the access mode 71(a) for the command 31(a) and/or keyword 33(a).

Referring now to FIGS. 2 and 8a, an exemplary embodiment for providing a different access mode 71((b) for a command 31(a) is shown via “COPY COMMAND <command> FROM <mode> TO <mode>” 80. For example, the improved CLI 25 may allow an input of the command 31(a) “set time” by a user that is in the operator mode but not by a user that is in the technician mode. It may be desirable to change the access mode 71 for the command 31(a) so that the user in the technician mode may use the command 31(a) in addition to the user in the operator mode, which is illustrated by “COPY COMMAND set time FROM operator TO technician” 82. Thus, the language definition 29 is administered so that the command 31(a), “set time” is available for the user in the access mode 71(a), operator mode, and for the user in the different access mode 71(b), technician mode. Although the exemplary embodiment uses the user input “COPY COMMAND <command> FROM <mode> TO <mode>” 80 to change the access mode 71(a), those skilled in the art would recognize that other user input may by used, such as “ADD ACCESS <command> TO <mode>”.

Referring now to FIGS. 2 and 8b, an exemplary embodiment for providing a different access mode 71(b) for a keyword 33(a) is shown via “COPY KEYWORD <command> FROM <mode> TO <mode>” 84. For example, the improved CLI 25 may allow an input of the keyword 33(a) “debug” by a user that is in the operator the mode but not by a user that is in the technician mode. It may be desirable to change the access mode 71 for the keyword 33(a) so that the user in the technician mode may use the keyword 33(a) as well as the user in the operator mode, which is illustrated by “COPY KEYWORD debug FROM operator TO technician” 86. Thus, the language definition 29 is administered so that the keyword 33(a), “debug” is available for the user in the access mode 71(a), operator mode, and is available for the user in the different access mode 71(b), technician mode. Although the exemplary embodiment uses the user input “COPY KEYWORD <keyword> FROM <mode> TO <mode>” 84 to change the access mode 71(a), those skilled in the art would recognize that other user input may by used, such as “CHANGE ACCESS <keyword> TO <mode>”.

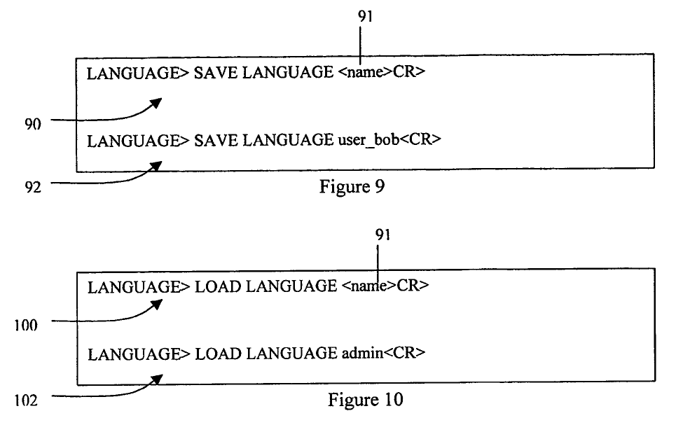

Referring now to FIGS. 2 and 9, an exemplary embodiment for saving a language definition 29 is provided via “SAVE LANGUAGE <name>” 90. The improved CLI 25 provides a save language command so that the administered language definition 29 may be saved. Preferably a name 91 is provided when saving the name so that more than one language definition 29 may be saved. However, the save language command may save the language definition 29 without a name. Furthermore, the “save language command preferably saves the help definition 27. However, the help definition 27 may be saved via a separate command, such as “SAVE HELP”. An example of saving the language definition 29 is illustrated by “SAVE LANGUAGE user_bob”, 92. Thus, the language definition 29 is saved with an associated name 91, “user_bob”.

Referring now to FIGS. 2 and 10, an exemplary embodiment for loading a language definition 29 is provided via “LOAD LANGUAGE <name>” 100. The improved CLI 25 provides a load language command so that the administered language definition 29 may be loaded. Preferably a name 91 is provided when loaded the name facilitating the use of more than one language definition 29. However, the load language command may load the language definition 29 without a name. Furthermore, the load language command preferably loads the help definition 27. However, the help definition 27 may be loaded via a separate command, such as “LOAD HELP”. An example of loading the language definition 29 is illustrated by “LOAD LANGUAGE admin”, 102. Thus, the language definition 29 with the associated name 91, “admin” is loaded for use by the improved CLI 25.

While the invention has been described in terms of a certain preferred embodiment and suggested possible modifications thereto, other embodiments and modifications apparent to those of ordinary skill in the art are also within the scope of this invention without departure from the spirit and scope of this invention. Thus, the scope of the invention should be determined based upon the appended claims and their legal equivalents, rather than the specific embodiments described above.

1. A method for an improved command line interface for a data processing system in a telephony device, comprising:
administering a language definition for an improved command line interface, the improved command line interface having a command and a keyword; and
storing the language definition.

2. The method according to claim 1, wherein the administering the language definition includes changing the command or the keyword.

3. The method according to claim 2, further comprising loading the language definition.

4. The method according to claim 3, wherein the administering the language definition includes removing the command or the keyword.

5. The method according to claim 4, wherein the improved command line interface includes a first access mode and a second access mode.

6. The method according to claim 5, wherein the administering the language definition includes changing the command from the first access mode to the second access mode.

7. The method according to claim 5, wherein the administering the language definition includes allowing a command with the first access mode to include the second access mode.

8. The method according to claim 1, further comprising administering a help definition.

9. The method according to claim 8, wherein the administering the help definition includes changing the command or keyword so that is hidden as help information.

10. The method according to claim 9, wherein the administering the help definition includes changing the command or keyword so that is visible as help information.

11. A software for providing a language definition, the software embodied in at least one computer-readable medium and when executed by one or more processors operable to:
accept user input from an input device; and
administer a language definition for an improved command line interface via the user input, the improved command line interface having a command and a keyword.

12. The software according to claim 11, wherein the language definition changes the command or the keyword.

13. The software according to claim 12, wherein the language definition removes the command or the keyword.

14. The software according to claim 13, wherein the language definition is saved or loaded.

15. The software according to claim 14, wherein the improved command line interface includes a first access mode and a second access mode.

16. The software according to claim 15, wherein the language definition changes the command from the first access mode to the second access mode.

17. The software according to claim 15, wherein the language definition allows a command with the first access mode to include the second access mode.

18. The software according to claim 11, further operable to change a help definition.

19. The software according to claim 18, wherein the help definition changes the command or keyword to be invisible.

20. The software according to claim 19, wherein the help definition is saved or loaded.
